(19) United States
(12) Patent Application Publication
(10) Pub. No.: US 2025/0260146 A1
(43) Pub. Date: Aug. 14, 2025

(54) POWER STORAGE DEVICE

(71) Applicant: TOYOTA JIDOSHA KABUSHIKI KAISHA, Toyota-shi (JP)

(72) Inventors: Kensuke MATSUO, Seto-shi (JP); Shigeyuki INOUE, Toyota-shi (JP); Shinya GOITSUKA, Nisshin-shi (JP)

(73) Assignee: TOYOTA JIDOSHA KABUSHIKI KAISHA, Toyota-shi (JP)

(21) Appl. No.: 19/013,298

(22) Filed: Jan. 8, 2025

(30) Foreign Application Priority Data
Feb. 9, 2024 (JP) 2024-018782

(51) Int. Cl. H01M 50/583; B60L 50/64; H01M 10/653; H01M 10/658; H01M 50/209; H01M 50/249; H01M 50/258; H01M 50/262; H01M 50/296

(52) U.S. Cl. CPC H01M 50/583; B60L 50/64; H01M 10/653; H01M 10/658; H01M 50/209; H01M 50/249; H01M 50/258; H01M 50/262; H01M 50/296; H01M 2200/103; H01M 2220/20

(57) ABSTRACT

A power storage device to be mounted on a vehicle includes a power storage unit, an inter-module fuse, a first external terminal, and a second external terminal. The power storage unit includes a first power storage module having a first electrode, and a second power storage module having a second electrode. The first electrode includes a first terminal electrically connected to the first external terminal, and a second terminal. The second electrode includes a third terminal electrically connected to the second external terminal, and a fourth terminal. The second terminal and the fourth terminal are electrically connected. The inter-module fuse is provided on an electrical path between the second terminal and the fourth terminal.

### CROSS REFERENCE TO RELATED APPLICATIONS

This nonprovisional application is based on Japanese Patent Application No. 2024-018782 filed on Feb. 9, 2024 with the Japan Patent Office, the entire contents of which are hereby incorporated by reference.

### BACKGROUND

### Field

The present disclosure relates to a power storage device.

### Description of the Background Art

For example, Japanese Patent Laying-Open No. 2023-046977 discloses a power storage device including an upper case, a lower case, and a power storage unit having a plurality of power storage modules. The power storage modules include a plurality of secondary battery cells having smoke discharge ports, and are accommodated in a case (the upper case and the lower case).

### SUMMARY

In a power storage device, it is considered that a fuse may be provided in a battery pack structure, for example, from the viewpoint of electrical protection.

For example, it is considered that the fuse may be disposed between an external terminal of the power storage device and power storage modules, as a safety device for preventing a high current exceeding specifications from flowing through an electronic device connected to the power storage device.

In the above-described power storage device, when a power storage module generates heat, an emission may be generated from the power storage module having generated heat.

The emission from the power storage module having generated heat may then cause a short circuit between the power storage module having generated heat and an adjacent power storage module, resulting in the formation of a short circuit in a power storage unit.

The fuse is provided between the external terminal and the power storage unit, and thus cannot perform the current interruption function even when the above-described short circuit is formed.

The present disclosure has been made in view of the above-described problem, and an object of the present disclosure is to provide a power storage device including a power storage unit having a plurality of power storage modules, in which the current interruption function is performed even when a short circuit is formed in the power storage unit.

A power storage device to be mounted on a vehicle, the power storage device including a power storage unit, an inter-module fuse, a first external terminal, and a second external terminal, wherein the power storage unit includes a first power storage module having a first electrode, and a second power storage module arranged adjacent to the first power storage module in a width direction and having a second electrode, the first electrode is disposed at one end of the power storage unit in the width direction, the first electrode includes a first terminal electrically connected to the first external terminal, and a second terminal, the second electrode is disposed at the other end of the power storage unit in the width direction, the second electrode includes a third terminal electrically connected to the second external terminal, and a fourth terminal, the second terminal and the fourth terminal are electrically connected, and the inter-module fuse is provided on an electrical path between the second terminal and the fourth terminal.

The power storage device further includes a terminal fuse, wherein the terminal fuse is provided on an electrical path between the second external terminal and the third terminal.

The power storage device, wherein the power storage unit includes a coupling bracket that couples the first power storage module and the second power storage module, and the coupling bracket is formed to protrude upward from the first power storage module and the second power storage module.

The power storage device further includes a third power storage module, wherein the third power storage module is disposed, with respect to the power storage unit, in an arrangement direction intersecting the width direction, the third power storage module is disposed between the one end and the other end in the width direction, and the inter-module fuse is disposed at a position adjacent to the third power storage module in the width direction.

The power storage device, wherein a heat insulating material is disposed above the inter-module fuse.

The power storage device, wherein the heat insulating material is provided with an opening that communicates with a space in the power storage device.

The power storage device further includes a lower case, wherein the inter-module fuse is disposed on the lower case with a thermally conductive member interposed therebetween.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a plan view schematically showing a power storage device according to the present embodiment.

FIG. 2 is a perspective view schematically showing a power storage module according to the present embodiment.

FIG. 3 is an exploded perspective view of the power storage module shown in FIG. 2.

FIG. 4 is a side view schematically showing a power storage cell according to the present embodiment.

FIG. 5 is a perspective view schematically showing a power storage unit according to the present embodiment.

FIG. 6 is an enlarged perspective view of a coupling bracket portion shown in FIG. 5 and its periphery.

FIG. 7 is a cross-sectional view taken along the line VII-VII shown in FIG. 1.

FIG. 8 is a cross-sectional view taken along the line VIII-VIII shown in FIG. 1.

FIG. 9 is a cross-sectional view taken along the line IX-IX shown in FIG. 1.

### DESCRIPTION OF THE PREFERRED EMBODIMENTS

Embodiments of the present disclosure will be described with reference to the drawings. In the drawings referenced below, the same or corresponding members are denoted by the same numbers.

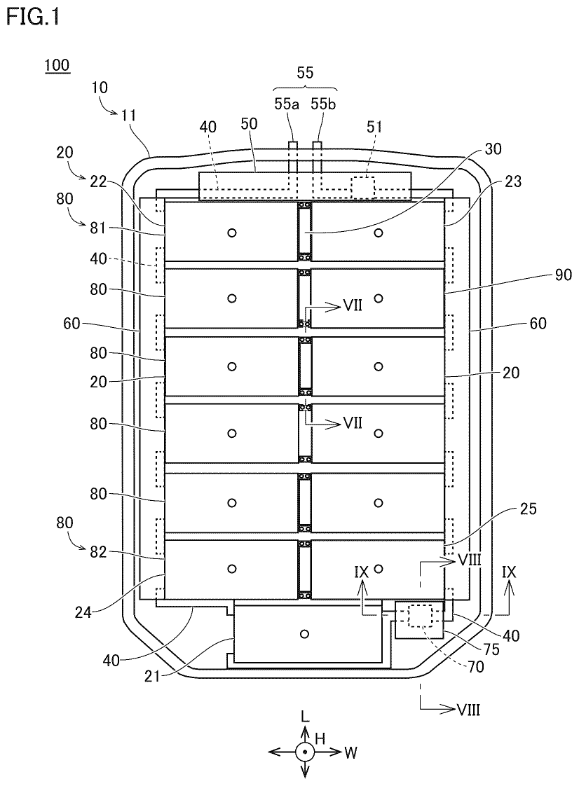

FIG. 1 is a plan view showing a power storage device according to the present embodiment. A length direction L, a width direction W, and an up-down direction H shown in FIG. 1 indicate the length direction, the width direction, and the up-down direction of the power storage device, respectively. A power storage device 100 is, for example, a device for storing electric power for driving an electrically powered vehicle (not shown). Width direction W is an example of “first direction” in the present disclosure, and length direction L is an example of “second direction” in the present disclosure.

Power storage device 100 includes a case 10, a power storage assembly 90, busbars 40, a junction box 50, an external terminal 55, and an inter-module fuse 70.

Case 10 accommodates power storage assembly 90, junction box 50, a protective cover 60, and inter-module fuse 70. Case 10 includes a lower case 11 and an upper cover 12 (not shown). Case 10 forms the shell of power storage device 100.

Lower case 11 is formed to open upward. When upper cover 12 is viewed at a distance in up-down direction H, upper cover 12 is formed to have the same outer shape as lower case 11. Lower case 11 and upper cover 12 are connected to thereby form a space R1.

Lower case 11 includes a bottom plate and a peripheral wall formed to extend upward from an outer peripheral edge of the bottom plate. The peripheral wall includes a front wall and a rear wall arranged in length direction L, and a right side wall and a left side wall arranged in width direction W.

Power storage assembly 90 includes a plurality of power storage units 80 and a power storage module 21. The plurality of power storage units 80 are disposed to be arranged in length direction L. Each power storage unit 80 includes one end surface and the other end surface arranged in width direction W. Each of the plurality of power storage units 80 includes power storage modules 20 arranged in width direction W, and a coupling bracket 30 that connects power storage modules 20 adjacent to each other in width direction W.

Power storage module 21 is disposed at a position adjacent to the plurality of power storage units 80 in length direction L. For example, power storage module 21 is provided rearward with respect to the plurality of power storage units 80.

Power storage module 21 is disposed at the center of power storage unit 80 in width direction W. Thus, power storage module 21 is located between the one end surface and the other end surface of power storage unit 80 in width direction W.

Accordingly, there is a dead space formed by power storage unit 80 and power storage module 21, at each position adjacent to power storage module 21 in width direction W.

Junction box 50 is provided at a position adjacent to power storage assembly 90 in length direction L. For example, junction box 50 is disposed forward with respect to power storage assembly 90. Junction box 50 is disposed on the inner surface side of the front wall of lower case 11.

External terminal 55 is provided on the front wall of lower case 11, and external terminal 55 is provided on an outer surface of the front wall of lower case 11.

Inter-module fuse 70 is disposed adjacent to power storage module 21 in width direction W.

The plurality of busbars 40 connect the plurality of power storage modules 20 to each other, and connect power storage module 20 and inter-module fuse 70.

Power storage device 100 is connected to a power control unit (PCU) and the like of the electrically powered vehicle by a power line and the like connected to external terminal 55.

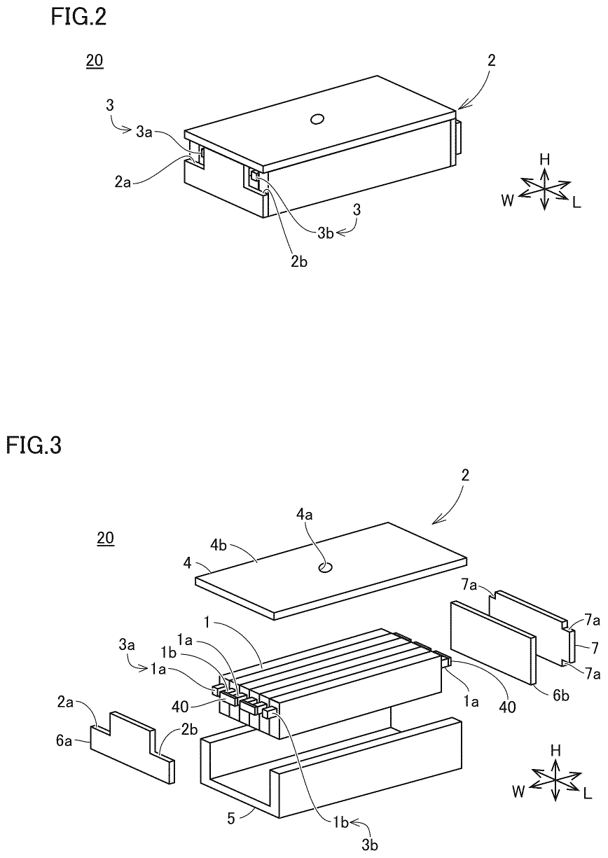

FIG. 2 shows a perspective view schematically showing the power storage module according to the present embodiment. Power storage module 20 is in the shape of a rectangular parallelepiped formed to extend in width direction W. Power storage module 20 includes a module case 2 and an electrode 3. Module case 2 has notches 2a and 2b at one end of a pair of wall surfaces arranged in width direction W. Electrode 3 includes a terminal 3a and a terminal 3b. Terminal 3a is exposed at notch 2a of module case 2, and terminal 3b is exposed at notch 2b of module case 2.

FIG. 3 shows an exploded perspective view of power storage module 20 shown in FIG. 2. Power storage module 20 includes a plurality of power storage cells 1 accommodated in module case 2.

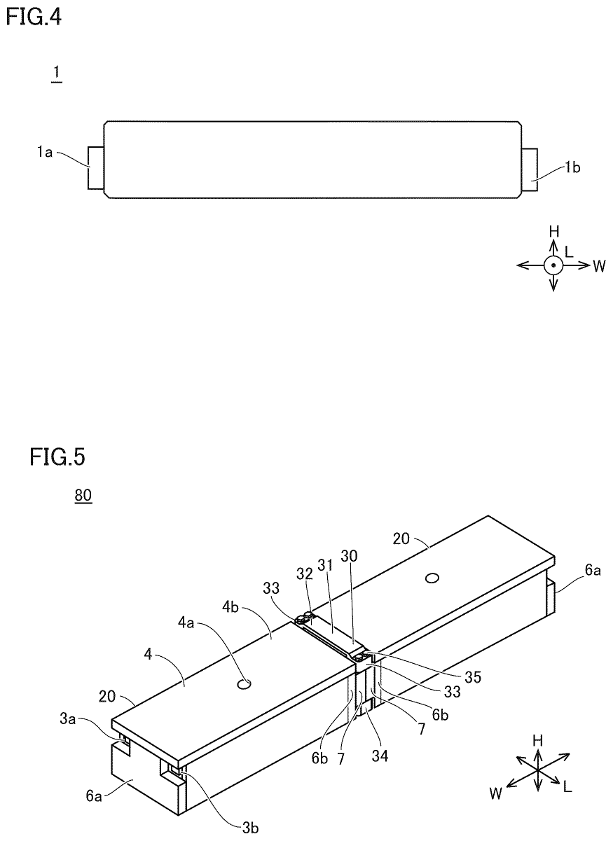

FIG. 4 shows a side view of the power storage cell. Power storage cell 1 is formed to extend in width direction W. Power storage cell 1 has electrode terminals 1a and 1b at both ends in width direction W. In width direction W, electrode terminal 1a is disposed at one end of power storage cell 1, and electrode terminal 1b is disposed at the other end of power storage cell 1. For example, electrode terminal 1a is a positive terminal and electrode terminal 1b is a negative terminal.

Referring again to FIG. 3, the plurality of power storage cells 1 are arranged in length direction L. When the plurality of power storage cells 1 are viewed at a distance in width direction W, electrode terminals 1a and electrode terminals 1b of power storage cells 1 are alternately arranged in length direction L.

In length direction L, one end of arranged electrode terminals 1a and 1b is electrode terminal 1a, and the other end is electrode terminal 1b. Electrode terminal 1a and electrode terminal 1b of adjacent power storage cells 1 are electrically connected in series by busbar 40. In the plurality of power storage cells 1 electrically connected in series, electrode terminal 1a at one end of a conductive path corresponds to terminal 3a of power storage module 20, and electrode terminal 1b at the other end corresponds to terminal 3b of power storage module 20.

Module case 2 includes an upper frame 4, a lower frame 5, insulating covers 6a and 6b, and an end plate 7.

Upper frame 4 is disposed to cover the plurality of power storage cells 1 from above. Upper frame 4 is provided with a plurality of gas discharge holes 4a. Gas generated from power storage cells 1 is discharged through gas discharge holes 4a.

Lower frame 5 is formed to cover lower surfaces and a pair of side surfaces arranged in length direction L of the plurality of power storage cells 1. Lower frame 5 supports the plurality of power storage cells 1 from below. Lower frame 5 is formed to sandwich the plurality of power storage cells 1 in length direction L.

The pair of insulating covers 6a and 6b are disposed to sandwich the plurality of power storage cells 1 in width direction W.

Insulating cover 6a is disposed on the surface provided with electrode terminals 1a and 1b corresponding to terminals 3a and 3b in width direction W. When insulating cover 6a is viewed at a distance in width direction W, insulating cover 6a is formed to cover the plurality of power storage cells 1, and additionally is provided with notches 2a and 2b to expose terminal 3a and terminal 3b.

Insulating cover 6b is disposed at a position facing insulating cover 6a with the plurality of power storage cells 1 interposed therebetween. When insulating cover 6b is viewed at a distance in width direction W, insulating cover 6b is formed to cover the plurality of power storage cells 1.

End plate 7 is disposed adjacent to insulating cover 6b in width direction W.

FIG. 5 shows a perspective view of the power storage unit. Power storage unit 80 includes a pair of power storage modules 20 and coupling bracket 30. Power storage module 20 are arranged in width direction W. Power storage unit 80 is formed so that insulating cover 6a is disposed at both ends in width direction W. Thus, in power storage unit 80, end plates 7 of the pair of power storage modules 20 are arranged to face each other. In power storage unit 80, the pair of power storage modules 20 are coupled by fastening the pair of end plates 7 facing each other to coupling bracket 30.

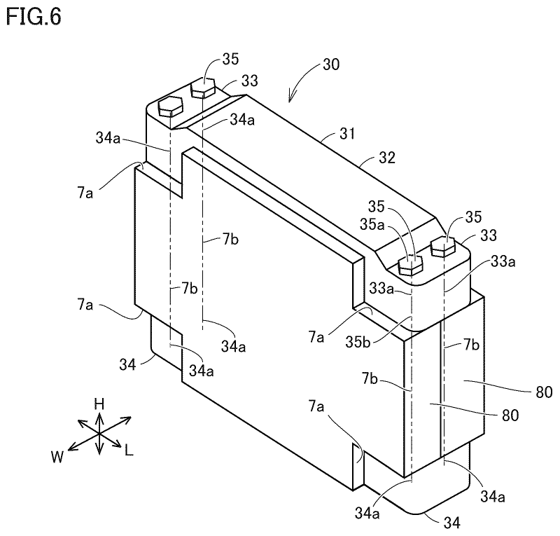

FIG. 6 shows an extracted and enlarged perspective view of a portion formed by the pair of end plates, the coupling bracket, and bolts shown in FIG. 5.

When end plate 7 is viewed at a distance in width direction W, end plate 7 is provided with notches 7a at its four corners. End plate 7 is provided with through holes 7b extending through notches 7a arranged in up-down direction H.

Coupling bracket 30 includes an upper member 31 and a pair of lower members 34.

Upper member 31 is formed to extend in length direction L. Upper member 31 is formed to cover the pair of end plates 7 of power storage unit 80. Upper member 31 includes a top plate 32 and a pair of end members 33.

Top plate 32 is formed to extend in length direction L. Top plate 32 is formed to cover upper surfaces of end plates 7.

The pair of end members 33 are arranged in length direction L. The pair of end members 33 are coupled by top plate 32. End members 33 are disposed on upper surfaces of notches 7a of the pair of end plates 7. Each of the pair of end members 33 is provided with two through holes 33a extending in up-down direction H.

Each of the pair of lower members 34 is located below each end member 33 and is formed to fit in notches 7a of end plates 7. Each lower member 34 is provided with two female threads 34a extending in up-down direction H. A screw thread is formed on the side of a hole forming each female thread 34a.

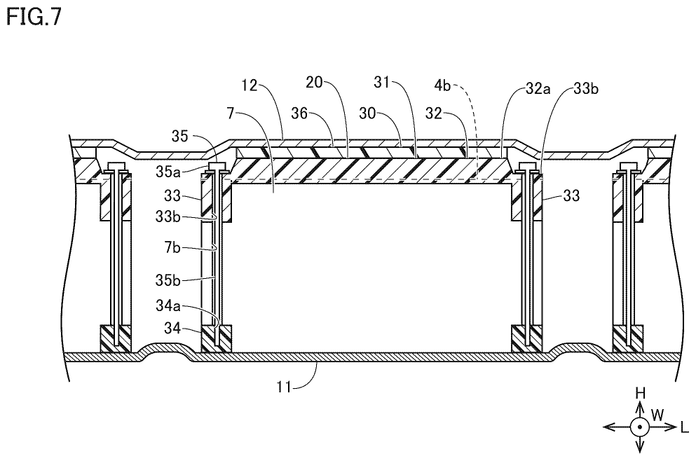

FIG. 7 is a cross-sectional view taken along the line VII-VII shown in FIG. 1. Through hole 7b of end plate 7, through hole 33a of end member 33, and female thread 34a of lower member 34 are coaxially formed.

A bolt 35 includes a bolt head 35a and a shaft 35b. Shaft 35b is inserted in a hole formed by through holes 7b and 33a and female thread 34a. Bolt 35 and lower member 34 are fastened with upper member 31 and end plate 7 interposed therebetween. Thus, the pair of end plates 7 are constrained by coupling bracket 30.

The plurality of power storage modules 20 are supported by lower case 11 from below. Upper member 31 of coupling bracket 30 and end plate 7 are in contact with each other without a gap in up-down direction H.

An upper surface 32a of top plate 32 of coupling bracket 30 is formed above an upper surface 4b of upper frame 4. Similarly, an upper surface 33b of end member 33 of coupling bracket 30 is formed above upper surface 4b of upper frame 4. That is, upper surfaces 32a and 33b of coupling bracket 30 protrude upward from upper surface 4b of power storage module 20. A heat insulating material 36 is disposed to fill a gap between upper cover 12 and top plate 32. Heat insulating material 36 may be formed integrally with top plate 32.

Referring again to FIG. 1, busbars 40 electrically connect junction box 50, inter-module fuse 70, power storage assembly 90, and external terminal 55 of power storage device 100. Thus, in power storage device 100, an electrical path is formed that terminates at a first external terminal 55a and a second external terminal 55b.

Specifically, busbar 40 electrically connects power storage units 80 arranged in length direction L. More specifically, busbar 40 electrically connects terminal 3a of power storage module 20 forming power storage unit 80 and terminal 3b of power storage module 20 adjacent thereto in length direction L.

In the plurality of power storage units 80 arranged in length direction L, a power storage unit 81 located at one end is connected to first external terminal 55a and second external terminal 55b. A power storage unit 82 located at the other end is electrically connected to power storage module 21.

More specifically, in power storage unit 81, terminal 3a of one power storage module 22 arranged in width direction W is electrically connected to first external terminal 55a, and terminal 3b of the other power storage module 23 arranged in width direction W is electrically connected to second external terminal 55b.

In power storage unit 82 located at the other end, terminal 3b of one power storage module 24 in width direction W is electrically connected to terminal 3a of power storage module 21. Terminal 3a of the other power storage module 25 in width direction W is electrically connected to terminal 3b of power storage module 21. Thus, power storage module 21 is provided on an electrical path formed by electrical connection between terminal 3b of power storage module 22 and terminal 3a of power storage module 23.

Junction box 50 accommodates electrical devices such as an SMR and a fuse of power storage device 100. In junction box 50, for example, a terminal fuse 51 is provided. Terminal fuse 51 is provided on an electrical path between terminal 3b of power storage module 23 included in power storage unit 81 and second external terminal 55b. Terminal fuse 51 is blown when a closed circuit is formed by connection of a drive electronic device and the like to external terminal 55 and a high current flows through it.

Power storage device 100 further includes protective cover 60. Protective cover 60 is provided to prevent conductive foreign substances from adhering to busbars 40. Protective cover 60 is formed to extend in length direction L. Protective cover 60 is arranged in width direction W. Protective cover 60 is disposed to cover busbars 40 electrically connecting power storage units 80 to each other.

Inter-module fuse 70 is provided on an electrical path between terminal 3b of power storage module 21 and terminal 3a of power storage module 25.

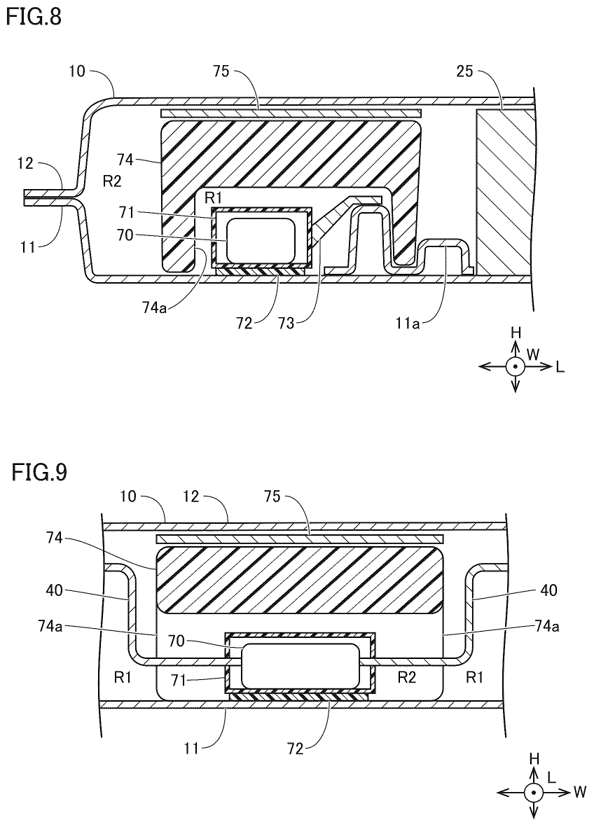

FIG. 8 shows a cross-sectional view taken along the line VIII-VIII shown in FIG. 1.

Inter-module fuse 70 is accommodated in a fuse case 71. Inter-module fuse 70 is fixed to a lower surface of fuse case 71.

Fuse case 71 is formed to surround inter-module fuse 70 on four sides. Fuse case 71 may be provided with a ventilation hole (not shown) for inter-module fuse 70 to exchange heat with outside air of fuse case 71. Fuse case 71 is disposed on lower case 11 with a thermally conductive member 72 interposed therebetween. Fuse case 71 includes a fixing member 73 formed to extend from fuse case 71. Fixing member 73 couples fuse case 71 and a reinforcement member 11a fixed on lower case 11. Thus, fuse case 71 is fixed on lower case 11.

FIG. 9 shows a cross-sectional view taken along the line IX-IX shown in FIG. 1. A heat insulating material 74 is disposed above fuse case 71. A cover 75 is disposed above heat insulating material 74 to cover heat insulating material 74. Heat insulating material 74 is provided with an opening 74a.

Opening 74a allows, in width direction W, a space R2 in which fuse case 71 is covered with heat insulating material 74 and space R1 formed by lower case 11 and upper cover 12 to communicate with each other.

Busbar 40 connected to inter-module fuse 70 is connected to electrode 3 through opening 74a.

In the embodiment described above, power storage device 100 disposes inter-module fuse 70 on the electrical path between power storage module 24 and power storage module 25. With such a configuration, power storage device 100 can be provided that can interrupt a high current by blowing inter-module fuse 70 even when conduction occurs between power storage modules 20 adjacent to each other in width direction W in power storage unit 80 and a short circuit occurs in power storage device 100.

In the embodiment described above, power storage unit 80 includes coupling bracket 30. Upper member 31 of coupling bracket 30 and end plate 7 are in contact with each other without a gap in up-down direction H. With such a configuration, smoke discharged from gas discharge holes 4a in upper frame 4 can be restrained from passing between upper member 31 and end plate 7. Thus, the flow of smoke in width direction W can be restrained in power storage unit 80.

Upper surface 32a of top plate 32 of upper member 31 and upper surface 33b of end member 33 are located above upper surface 4b of upper frame 4. With such a configuration, smoke discharged from gas discharge holes 4a in upper frame 4 can be restrained from passing above top plate 32 and end member 33. Thus, the flow of smoke in width direction W can be restrained in power storage unit 80.

In the embodiment described above, heat insulating material 36 is disposed to fill the gap between upper cover 12 and top plate 32. With such a configuration, the flow of smoke in width direction W can be restrained in power storage unit 80.

In the embodiment described above, power storage module 21 is disposed, in length direction L, at one end of the plurality of power storage units 80 arranged in length direction L. Power storage module 21 is also located, in width direction W, between one end and the other end of power storage unit 80. Further, inter-module fuse 70 is disposed at a position adjacent to power storage module 21 in width direction W. With such a configuration, dead space formed at the position adjacent to power storage module 21 in the width direction can be effectively used.

In the embodiment described above, heat insulating material 74 is disposed above inter-module fuse 70. With such a configuration, inter-module fuse 70 can be protected from high-temperature discharged smoke generated from power storage module 20.

Further, heat insulating material 74 is provided with opening 74a that allows space R1 and space R2 to communicate with each other. With such a configuration, cold air in space R1 flows into space R2 through opening 74a. Thus, inter-module fuse 70 can be cooled.

In the embodiment described above, inter-module fuse 70 is disposed on fuse case 71. Fuse case 71 is disposed on lower case 11 with thermally conductive member 72 interposed therebetween. Lower case 11 has a higher thermal capacity than fuse case 71. With such a configuration, heat of inter-module fuse 70 can be dissipated to lower case 11 through fuse case 71 and thermally conductive member 72.

While the gap between upper cover 12 and top plate 32 is filled with heat insulating material 36 in the exemplary embodiment described above, the present disclosure is not limited as such. For example, there may be no heat insulating material 36, and there may be a gap between upper cover 12 and top plate 32. Instead, upper surface 32a of top plate 32 and upper surface 33b of end member 33 are each formed to be located above upper surface 4b of upper frame 4 of power storage module 20. With such a configuration, smoke discharged from gas discharge holes 4a in upper frame 4 can be restrained from passing above coupling bracket 30. Thus, the flow of smoke in width direction W can be restrained in power storage unit 80.

Although the embodiments of the present disclosure have been described, it should be understood that the embodiments disclosed herein are illustrative and non-restrictive in every respect. The scope of the present disclosure is defined by the terms of the claims, and is intended to include any modifications within the scope and meaning equivalent to the terms of the claims.

What is claimed is:

1. A power storage device to be mounted on a vehicle,
the power storage device comprising a power storage unit, an inter-module fuse, a first external terminal, and a second external terminal, wherein
the power storage unit includes a first power storage module having a first electrode, and a second power storage module arranged adjacent to the first power storage module in a first direction and having a second electrode,
the first electrode is disposed at one end of the power storage unit in the first direction,
the first electrode includes a first terminal electrically connected to the first external terminal, and a second terminal,
the second electrode is disposed at the other end of the power storage unit in the first direction,
the second electrode includes a third terminal electrically connected to the second external terminal, and a fourth terminal,
the second terminal and the fourth terminal are electrically connected, and
the inter-module fuse is provided on an electrical path between the second terminal and the fourth terminal.

2. The power storage device according to claim 1, further comprising a terminal fuse, wherein
the terminal fuse is provided on an electrical path between the second external terminal and the third terminal.

3. The power storage device according to claim 1, wherein
the power storage unit includes a coupling bracket that couples the first power storage module and the second power storage module, and
the coupling bracket is formed to protrude upward from the first power storage module and the second power storage module.

4. The power storage device according to claim 1, further comprising a third power storage module, wherein
the third power storage module is disposed, with respect to the power storage unit, in a second direction intersecting the first direction,
the third power storage module is disposed between the one end and the other end in the first direction, and
the inter-module fuse is disposed at a position adjacent to the third power storage module in the first direction.

5. The power storage device according to claim 1, wherein a heat insulating material is disposed above the inter-module fuse.

6. The power storage device according to claim 5, wherein the heat insulating material is provided with an opening that communicates with a space in the power storage device.

7. The power storage device according to claim 1, further comprising a lower case, wherein
the inter-module fuse is disposed on the lower case with a thermally conductive member interposed therebetween.
